(19) United States
(12) Patent Application Publication
(10) Pub. No.: US 2025/0094678 A1
(43) Pub. Date: Mar. 20, 2025

(54) SINGLE LOOP HYBRID SEARCH FOR DESIGNING FIRE FIGHTING FLOW CAPACITY

(71) Applicant: Autodesk, Inc., San Francisco, CA (US)

(72) Inventor: Felipe Hernandez Cruz, Pittsburgh, PA (US)

(73) Assignee: Autodesk, Inc., San Francisco, CA (US)

(21) Appl. No.: 18/886,906

(22) Filed: Sep. 16, 2024

Related U.S. Application Data
(60) Provisional application No. 63/583,204, filed on Sep. 15, 2023.

(51) Int. Cl. G06F 30/28; G06F 30/27; G06F 113/08

(52) U.S. Cl. CPC G06F 30/28; G06F 30/27; G06F 2113/08

(57) ABSTRACT

A method and system provide the ability to determine a hydrant fire flow. Inputs are obtained A critical element is identified. Based on a physical-based heuristic, a new hydrant fire flow guess is determined. The search direction is evaluated and used to maintain/override (using a heuristic method) the fire flow guess. The new guess is assigned as a hydrant demand. Network pressure and flow values are updated. The constraints are evaluated. The guess is reduced if at least one constraint has been violated and increased of all constraints have been satisfied. The new guess is evaluated for convergence and if not converged, the process repeats.

### CROSS-REFERENCE TO RELATED APPLICATIONS

This application claims the benefit under 35 U.S.C. Section 119 (e) of the following co-pending and commonly-assigned U.S. provisional patent application(s), which is/are incorporated by reference herein:

U.S. Provisional Application Ser. No. 63/583,204, filed on Sep. 15, 2023, with inventor(s) Felipe Hernandez Cruz, entitled “SINGLE LOOP HYBRID SEARCH FOR DESIGN FIRE FIGHTING FLOW CAPACITY COMPUTATION” attorneys' docket number 30566.0615USP1.

### BACKGROUND OF THE INVENTION

### 1. Field of the Invention

The present invention relates generally to fire hydrant design and placement, and in particular, to a method, system, apparatus, and article of manufacture for determining the capacity of a fire hydrant (and its network) to fight fire emergencies.

### 2. Description of the Related Art

(Note: This application references a number of different publications as indicated throughout the specification by reference numbers enclosed in brackets, e.g., [x]. A list of these different publications ordered according to these reference numbers can be found below in the section entitled “References.” Each of these publications is incorporated by reference herein.) In various countries, there is a requirement that water distribution systems need to have a spare capacity to fight fires. Engineers are required to design systems to provide this extra capacity. In particular, engineers must estimate, at every fire hydrant, the amount of water needed to fight a fire. This amount of water is compared to what a water network can actually deliver without affecting the normal water pressure for customers (that utilize the water).

The hydrant fire flow (also referred to as design hydrant fire flow and/or design fire flow) is the maximum flow that can be extracted from a hydrant without significantly affecting normal users throughout a fire hydrant network system. The hydrant fire flow is used to determine the capacity of the system to fight fire emergencies. To determine whether users are significantly affected when extracting flow from the hydrant, minimum pressures need to be met at consumption points in the network (a set of junctions “of interest”). An additional constraint can be enforced, in which velocities in pipes should not surpass dangerous levels (such that they would cause discoloration, exceed the pipe capacity, etc.). This hydrant fire flow analysis needs to be carried out individually for many hydrants in the network and, thus, big models usually require significant computation times to complete. It is therefore important to guarantee that an algorithm that searches for design fire flow values is efficient.

Prior art systems utilize a time consuming process where a fire hydrant network system/model is evaluated one hydrant at a time. The flow out of a hydrant is determined and slowly increased to determine the maximum flow that can be obtained before it drops below a required minimum. This design fire flow analysis needs to be carried out individually for many hydrants in the network and, thus, big models usually require significant computation times to complete. It is therefore important to guarantee that the algorithm that searches for the design fire flow values is efficient

To better understand these problems, a more detailed description of prior art methods and processing may be useful.

Prior art algorithms used in products (e.g., in INFO WATER™ and INFOWATER PRO™ [available from the assignee of the present application]) are based on the method by [Boulos 1997], with subsequent enhancements by Chun-Hou Orr to ensure adequate solutions for edge cases.

FIG. 1 illustrates the logical flow for fire flow analysis for each hydrant under normal load conditions in the prior art.

At step 102, the fire demand is determined. More specifically, the service level in the network with an added user-defined fire flow demand is determined.

At step 104, the available flow is determined. More specifically, the maximum available flow while maintaining residual pressure at the hydrant (optional: and low velocities in connecting pipes) is determined.

At step 106, the design flow is determined. More specifically, the maximum available flow while maintaining the service level in the network (optional: and low velocities in connecting pipes) is determined.

FIG. 2 illustrates the logical flow for the performance phase of the design flow determination (i.e., step 106 of FIG. 1) in accordance with the prior art. The steps of FIG. 2 all comprise a critical node loop 200 (for the performance phase of the design flow determination) in which the steps are repeated for each hydrant until the process is done or a maximum (predefined) number of iterations have been performed.

At step 202, a critical node candidate is found/identified. As used herein a critical node candidate is a potential pressure value for the hydrant being examined.

Loop 204 consists of the hydrant flow loop which is performed until the critical hydrant flow has been determined and/or a maximum (predefined) number of iterations have been performed.

At step 206, the system guesses a new hydrant flow (using a physically-based heuristic (PHYS)).

At step 208, the flow guess is assigned to the hydrant.

Hydraulic loop 210 is performed until the pressure values converge and/or until a maximum (predefined) number of iterations are reached.

At step 212, the network pressures and flow values are updated.

At step 214, the hydraulic convergence is evaluated. If convergence has been reached, the system exits/breaks the hydraulic flow loop 210. If convergence has not been reached (and the maximum number of iterations has not been exceeded), the loop 210 repeats by returning to step 212.

At step 216, the critical node pressure is evaluated. If the target pressure has been reached, the system exits/breaks the hydrant flow loop 204. If the target pressure has not been reached (and the maximum number of iterations has not been exceeded), the loop 204 repeats by returning to step 206.

At step 218, constraint compliance is evaluated. If all constraints have been met (and/or the maximum number of iterations have been reached), the system exits/breaks. If the constraints have not been met (and/or the maximum number of iterations have been reached), the system returns to step 202.

FIG. 3 illustrates the logical flow for the “exploratory” phase of the design flow determination (i.e., step 106 of FIG. 1) in accordance with the prior art. The steps of FIG. 3 are performed for DW models or if the “performance” phase in FIG. 2 failed. The steps of FIG. 3 all comprise a critical node loop 300 (for the performance phase of the design flow determination) in which the steps are repeated for each hydrant until the process is done or a maximum (predefined) number of iterations have been performed.

At step 302, a critical node candidate is found/identified.

Loop 304 consists of the hydrant flow loop which is performed until the critical hydrant flow has been determined and/or a maximum (predefined) number of iterations have been performed.

At step 306, the system guesses a new hydrant flow (using a local search heuristic).

At step 308, the flow guess is assigned to the hydrant.

Hydraulic loop 310 is performed until the pressure values converge and/or until a maximum (predefined) number of iterations are reached.

At step 312, the network pressures and flow values are updated.

At step 314, the hydraulic convergence is evaluated. If convergence has been reached, the system exits/breaks the hydraulic flow loop 310. If convergence has not been reached (and the maximum number of iterations has not been exceeded), the loop 310 repeats by returning to step 312.

At step 316, the critical node pressure is evaluated. If the target pressure has been reached, the system exits/breaks the hydrant flow loop 304. If the target pressure has not been reached (and the maximum number of iterations has not been exceeded), the loop 304 repeats by returning to step 306.

At step 318, constraint compliance is evaluated. If all constraints have been met (and/or the maximum number of iterations have been reached), the system exits/breaks. If the constraints have not been met (and/or the maximum number of iterations have been reached), the system returns to step 302.

In view of the above, it can be seen that prior art implementations are complex both in logic and code structure. Prior art systems are also inefficient (at least in some special cases). This inefficiency is manifested in repeated calls to a hydraulic solver (e.g., hydraulic loop 210 and 310 of FIGS. 2 and 3) to test the validity of a candidate design fire flow guess. Core to prior art inefficiencies include:
(1) The reliance on identifying a “critical junction” at different times during the search (i.e., at step 202 of FIG. 2 and at step 302 of FIG. 3). Critical junctions are those junctions for which the minimum acceptable pressure corresponds to the case in which the design fire flow is found. Throughout the algorithm, multiple junctions are usually marked as candidates/suspects of being a critical junction (i.e., at steps 202 of FIGS. 2 and 302 of FIG. 3), leading to repeating the search multiple times;
(2) The need to perform multiple verification runs, in which, after a solution for the design fire flow has presumably been found, the algorithm proceeds to make additional calls to the hydraulic solver (i.e., the hydraulic loop 210 and 310) to verify the solution; and
(3) The need to rely solely on a heuristic search method (i.e., the local search heuristic at step 306 of FIG. 3) when the Darcy-Weisbach equation is used to describe the head losses in the pipes, pipe velocities are used as additional constraints, or whenever a physically-based method (i.e., the method of FIG. 2) fails.

In view of the above, it may be noted that fire flow analyses are widely and frequently performed due to regulation. They are also very computationally intensive given that they require running the models numerous times for each hydrant. Some customers with large models thus may execute runs that last multiple hours and even multiple days. Any hydraulic modeling product that addresses this major pain point for these customers would indeed score very high in their sheet. While parallelization may potentially accelerate these workflows, it may still not produce an effective and efficient result. Accordingly, what is needed is a method/system/algorithm that accurately and efficiently performs a fire flow analysis for a water distribution system.

### SUMMARY OF THE INVENTION

Embodiments of the invention provide a modified fire flow module that features an algorithm whose purpose is to find the design fire flow for a single hydrant very efficiently. The algorithm is to be utilized iteratively for all hydrants in a water distribution network. More specifically, embodiments of the invention follow a single loop that determines a search direction, finds critical elements, guess new hydrant flow, replaces the guess if the search direction was wrong, assigns a flow guess to a hydrant, updates network pressures and flow values, evaluates if all constraints are satisfied or if at least one is violated, and evaluates for hydraulic and flow guess convergence. Such steps efficiently determine the fire flow for each hydrant in a water distribution system.

### BRIEF DESCRIPTION OF THE DRAWINGS

Referring now to the drawings in which like reference numbers represent corresponding parts throughout:

FIG. 1 illustrates the logical flow for fire flow analysis for each hydrant under normal load conditions in the prior art;

FIG. 2 illustrates the logical flow for the performance phase of the design flow determination (i.e., step 106 of FIG. 1) in accordance with the prior art;

FIG. 3 illustrates the logical flow for the “exploratory” phase of the design flow determination (i.e., step 106 of FIG. 1) in accordance with the prior art;

FIG. 4 illustrates the logical flow for determining hydrant fire flow in accordance with one or more embodiments of the invention;

FIG. 5 illustrates the logical flow for finding the critical element (CRIT) in accordance with one or more embodiments of the invention;

FIG. 6 illustrates the logical flow for using physically based criteria on the critical element to determine a next guess in accordance with one or more embodiments of the invention;

FIG. 7 illustrates the three points that the system is attempting to fit the curve to in accordance with one or more embodiments of the invention;

FIG. 8 illustrates a quadratic curve fitting through all three points in accordance with one or more embodiments of the invention;

FIG. 9 illustrates the logical flow for the heuristic method for overriding a guess in accordance with one or more embodiments of the invention;

FIG. 10 illustrates the local search heuristic in accordance with one or more embodiments of the invention;

FIG. 11 is an exemplary hardware and software environment used to implement one or more embodiments of the invention; and

FIG. 12 schematically illustrates a typical distributed/cloud-based computer system in accordance with one or more embodiments of the invention.

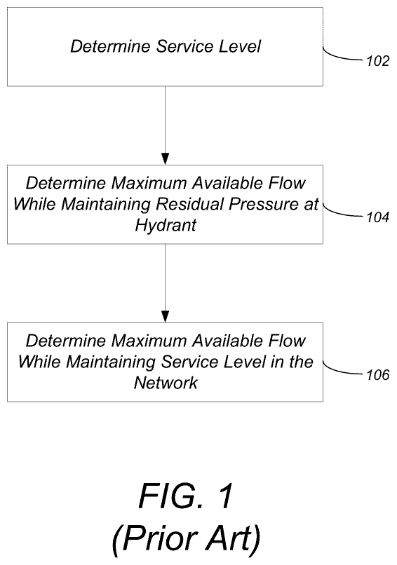

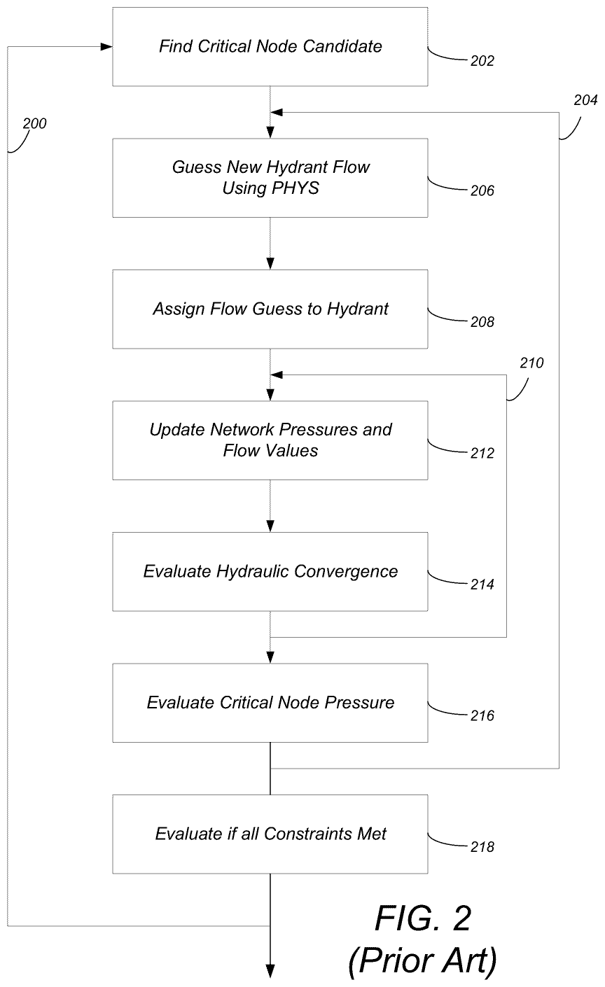

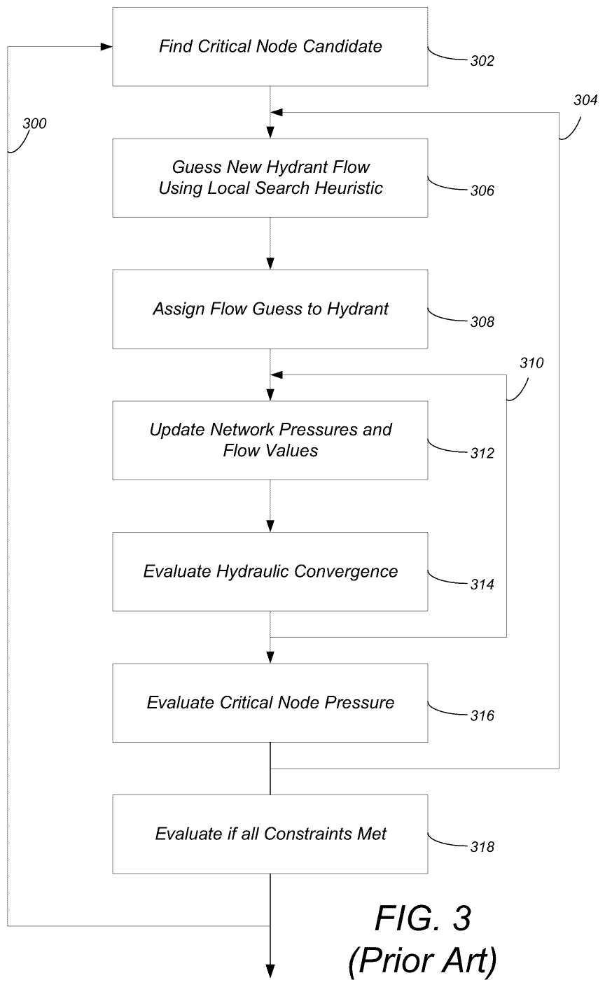

### DETAILED DESCRIPTION OF THE INVENTION

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Strategic Overview

Embodiments of the invention provide a design fire flow algorithm using one or more of the following three strategies:

(1) Evaluate the validity of a proposed value for the design fire flow by simultaneously analyzing pressure (and velocity) violations in all junctions (and pipes) of interest. That is, running the hydraulic engine provides the information necessary to evaluate all elements of interest and thus to determine three possible states:
(a) Excessive flow: at least one element of interest has a constraint violation. Action to take: reduce the flow.
(b) Deficient flow: none of the elements of interest have constraint violations. Action to take: increase the flow.
(c) Correct flow: none of the elements of interest have constraint violations and there is at least one for which the constrained variable sits right at its threshold. Action to take: the search is complete; elements at their thresholds are deemed critical.

(2) Couple the search for the design fire flow within the hydraulic solver loop. Instead of having an outer loop that proposes new values for the flow, and an inner loop that solves the hydraulic equations; embodiments of the invention simultaneously search for both the design fire flow and the correct hydraulic solution. The nested loop approach (of the prior art) is inefficient in that it needs to complete all the iterations of the hydraulic solver even when it is evident from early iterations that the proposed flow is wrong. Note that this is analogous to the way in which VSP (variable speed pump) settings and pressure-dependent demands are solved: that is, additional steps are included in the hydraulic solver loop to account for the extra unknowns. Although the additional uncertainty of these unknowns results in a more complex search, the additional iterations needed are worth avoiding running the simpler solver multiple times. To this end, the enhanced solver (of embodiments of the invention) would include an extra step when including demands into the matrix system each iteration. The new guess for the design fire flow is introduced each iteration based on the measured state of the elements of interest. This step needs to loop through the current estimates of the variables in all the elements of interest to provide an adequate guess.

(3) Hybridize physically based and heuristic criteria to propose next guesses for the design fire flow. The current algorithm utilizes a physically based criterion in a first “formulation” phase, and then a heuristic criterion in a second “exploration” phase, in case the first one failed to find a satisfactory solution. The physically based criterion is explained in [Boulos 1997] and is built on the observed relationship between hydrant flow (Q) and pressure (P) in a hydraulically connected point in the network. This relationship, barring special controls, states that Q P⁵⁴ Even with controls, this relationship has been found to hold locally in between control regimes. A similar relationship is available if the critical variable is pipe velocity. The heuristic search method uses a binary search (or bisection) to reduce the possible range of solutions with logarithmic efficiency.

The overhaul of embodiments of the invention uses a version of the physically based approach by approximating a degree-2 polynomial to the Q-P relationship using the last three iterations, and then solving for Q by plugging in the target P. P is measured at the junction currently believed to be critical (for instance, the one with a pressure value closest to the threshold). For the first iteration, the results from the static, user fire flow, and available flow runs are used to fit the curve. Given the expected instability of the Q-P pairs while solving the network hydraulics simultaneously, or because of control regime transitions, it is possible that the proposed new Q is not in the direction expected given the current measured constraint satisfaction state. In these cases, the physically based approach is overridden by a heuristic local search approach. The local search considers the last Q and applies a damping factor if the direction of search needs to be reversed, and potentially a boosting factor if the direction is the same as in the last iteration. A binary search was discarded given that it is not necessarily efficient to know beforehand what the upper bound for Q might be.

Together, these three strategies aim at collapsing the current multi-phase, 4-level nested-loop approach into a single-phase, single-loop one with significant expected gains in efficiency. Additional computation-preserving tactics may include one or more of the following:
Edge case checking: the design fire flow is determined to be zero if the static simulation does not satisfy the pressure (and velocity) constraints. The design fire flow is determined to be equal to the available flow if there are no violated constraints in this case and the hydrant itself is included in the junctions of interest.
No difference in strategy for simulations using the Darcy-Weisbach pipe headloss equation. It has been stated that the exponent in the Q-P relationship in [Boulos 1997] is valid only for networks that use the Hazen-Williams equation. Therefore, only the heuristic approach is currently used for networks using the Darcy-Weisbach equation. Embodiments of the invention still use the physically based criterion in all cases given that the approximation of the Q-P relationship with a degree-2 polynomial curve is an accurate enough representation of real systems.
Exclusion of insensitive junctions and pipes to the fire flow from the list of elements of interest. After having run the static, user fire flow, and available fire flow simulations, it is possible to measure the sensitivity of these variables to changes in the fire flow, and to discard those whose response is marginal next to the normalized response at the hydrant itself. This would marginally increase the performance by reducing the number of elements to verify each iteration and could also please users who dislike seemingly unrelated elements to be flagged as critical.

Embodiments of the invention provide a design fire flow algorithm that can be divided into the following tasks:

(1) Create list of elements of interest, together with their pressure or velocity threshold. Remove those that are insensitive to fire flow changes in the hydrant by comparing responses between the static, user fire flow, and available fire flow simulations.

(2) Constraint violation evaluation function. For a given estimate of network pressures and velocities, and the list of elements of interest, determine the current design fire flow estimation state: excessive flow, deficient flow, or correct flow. Store the hydraulic results for the pressure or velocity of the elements of interest for the last three iterations.

(3) Local search design fire flow guess. Given the Q in the previous iteration, the flow estimation state, and the damping/boosting factors; modify the design fire flow guess within the hydraulic solver loop;

(4) Select a critical element of interest. Within the constraint evaluation function, select one element of interest as critical, for example, the one closest to its constraint threshold (either in absolute or relative terms).

(5) Physically based design fire flow guess. Given the Q-P (or Q-V) pairs from the previous three iterations and a critical element, fit a degree-2 polynomial curve; and estimate the design fire flow for the next iteration using the target pressure (or velocity).

(6) Algorithm control logic. Rule out edge cases at the beginning, verify hybrid physically based/heuristic guess switching, implement loop termination logic (i.e., when both the hydraulic solver converges, and the correct flow state has been reached; or when an edge case solution has been identified), etc.

The details for these tasks following the above-identified strategies are described in further detail in the subsequent section.

### Detailed Implementation

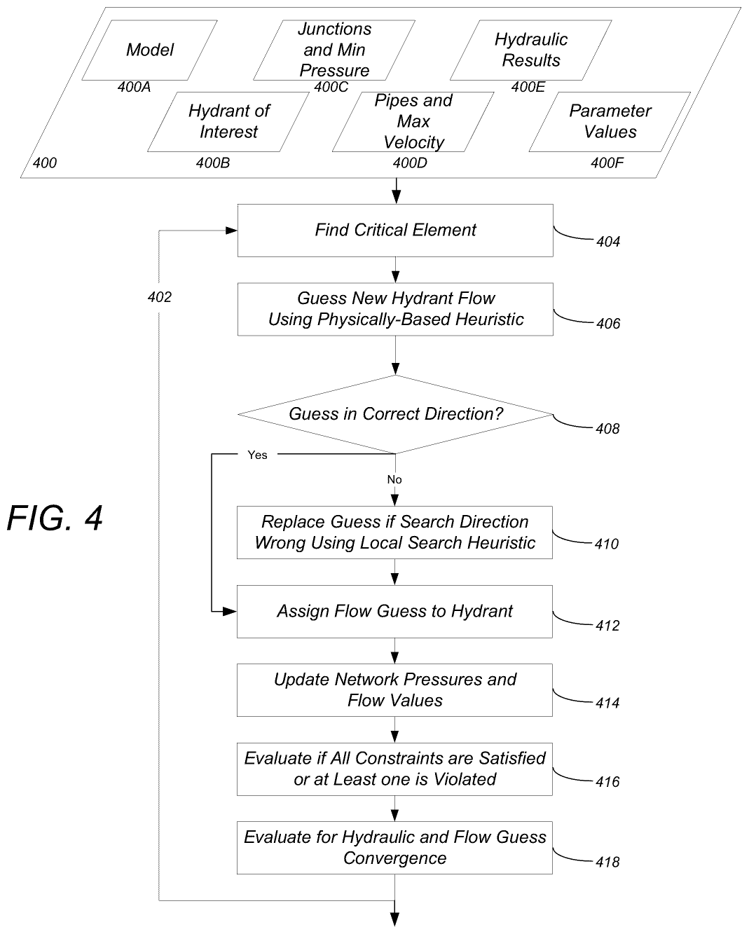

As described above, embodiments of the invention provide a modified fire flow module that features an algorithm whose purpose is to find the design fire flow for a single hydrant very efficiently. The algorithm is to be utilized iteratively for all hydrants in a water distribution network. FIG. 4 illustrates the logical flow for determining hydrant fire flow in accordance with one or more embodiments of the invention.

The algorithm may require various inputs 400 including:
A model 400A of the water network (e.g., an INFOWORLD PRO model).
Hydrant of interest 400B (i.e., a fire hydrant identification for a fire hydrant of interest).
List of junctions with a minimum pressure threshold to satisfy (and the values for these thresholds [referred to as minimum pressure threshold values]) 400C. As used herein, the minimum pressure threshold is a constraint (referred to in the claims as a first constraint) in a set of constraints.
List of pipes with a maximum velocity threshold to satisfy (and the values for these thresholds [referred to as maximum velocity threshold values]) 400D. As used herein, the maximum velocity threshold is a constraint (referred to in the claims as a second constraint) in the set of constraints.
Hydraulic results 400E for {three specific) “base” conditions for the fire hydrant of interest: (1) With “static” demand: normal water flow demand for normal water operations; (2) With “user-defined” fire demand: emergency demand the user estimates will occur during a fire emergency; and (3) With “available” fire demand: maximum flow that can be extracted from the fire hydrant without lowering its pressure below a given value.
Values for some parameters 400F (e.g., maximum number of iterations, local search change multipliers, convergence precision values, etc.). In this regard, the parameter values 400F are for those parameters required to determine the hydrant fire flow.

The algorithm consists of a single loop 402. The loop 402 is seeded with the hydraulic results 400E from the three base conditions as if these were the results from three previous iterations of the loop 402.

The constraints are defined based on the pressure 400C and velocity threshold 400D values for the elements of interest 400B. The loop 402 starts assuming the last design fire flow “guess” (corresponding to the available flow) is excessive. The loop 402 consists of steps 404-416. As described herein, embodiments of the invention utilize a single loop that combines the critical junction search, the hydrant flow search, and the hydraulic solver together.

At step 404, a critical element (of the water network model) is found/identified. In one or more embodiments, the critical element is found by prioritizing violated constraints (in the set of constraints), the relative pressure distance to a target (i.e., to the minimum pressure threshold value), and a relative velocity distance to a target (i.e., to the maximum velocity threshold value). In other words, the relative distance to the target pressure is utilized to determine whether it is a critical element or not (i.e., instead of using absolute distances in terms of pressure). More specifically, embodiments may use the CRIT methodology (see description of the CRIT methodology below).

At step 406, physically-based criteria (PHYS) are used on the critical element to find the next guess. In this regard, with the critical element, a guess for a new hydrant flow (i.e., a new hydrant fire flow guess) is determined using a physically-based heuristic. Such a methodology attempts to fit a quadratic curve to the last three guesses. A more detailed description of the PHYS based criteria is set forth below.

At step 408, a determination is made regarding whether the new hydrant fire flow guess is moving in the right/correct/adequate search direction. In this regard, for the direction, if the constraints (i.e., the first constraint and/or the second constraint) are satisfied, the hydrant flow should be increased, and if the constraints are violated, the hydrant flow should be decreased. Accordingly, depending on whether the constraints have been violated or not, the hydrant flow guess should be higher or lower than the prior guess. More specifically, the adequate search direction provides for a reduced fire flow when the constraints are violated and an increased flow when the constraints are satisfied. At step 410, if the hydrant flow moved in wrong/incorrect direction, the original guess (i.e., the new hydrant fire flow guess) is replaced/overridden using a heuristic method (HEUR) (i.e., a local search heuristic). A more detailed description of the HEUR is described below.

Thus, if the new hydrant fire flow guess was consistent with (i.e., is in) the correct/adequate search direction, the guess is maintained.

At step 412, the new hydrant fire flow guess is assigned as a hydrant demand of the fire hydrant of interest.

At step 414, the network pressure value and network flow value are updated. In this regard, step 414 may include performing head and flow estimation steps of a hydraulic analysis (e.g., using a Global Gradient Algorithm—GGA).

At step 416, the set of constraints are evaluated. In particular, if at least one constraint in the set is violated, the new hydrant fire flow guess should be/is reduced. Alternatively, if all of the constraints (in the set) are satisfied, the new hydrant fire flow guess should be/is increased.

At step 418, convergence (i.e., hydraulic and flow guess convergence) is evaluated (for the new hydrant fire flow guess). The loop 402 is exited (i.e., the algorithm breaks) if there is convergence and the loop 402 repeats if convergence has not resulted. As used herein, convergence occurs when: GGA stopping criteria has been met, all constraints (in the set of constraints) are/have been satisfied, and the guess did not change noticeably (e.g., below a threshold change value) (e.g., when the new hydrant fire flow guess is within a threshold distance of a prior hydrant fire flow guess from a last/prior iteration. If any of the above conditions have not been met, the loop 402 repeats at step 404 using the new guess.

In view of the above, the hydrant fire flow analysis of FIG. 4 is performed for each hydrant in a single loop that simultaneously solves for the hydrant fire flow and hydraulic conditions present when the hydrant fire flow occurs.

In addition, the steps of FIG. 4 are repeated for all hydrants in the water network model. Thereafter, a physical manifestation of the water network (i.e., the actual water network itself) is updated and/or built/constructed based on the new hydrant fire flow guesses. Such an update/construction may include adding/removing the number of fire hydrants, moving/placing the fire hydrants in particular locations, updating/placing specific pipes (i.e., pipes with specific sizes/capacities), and/or updating/placing/enabling certain water pressures throughout the water distribution system/network.

### CRIT

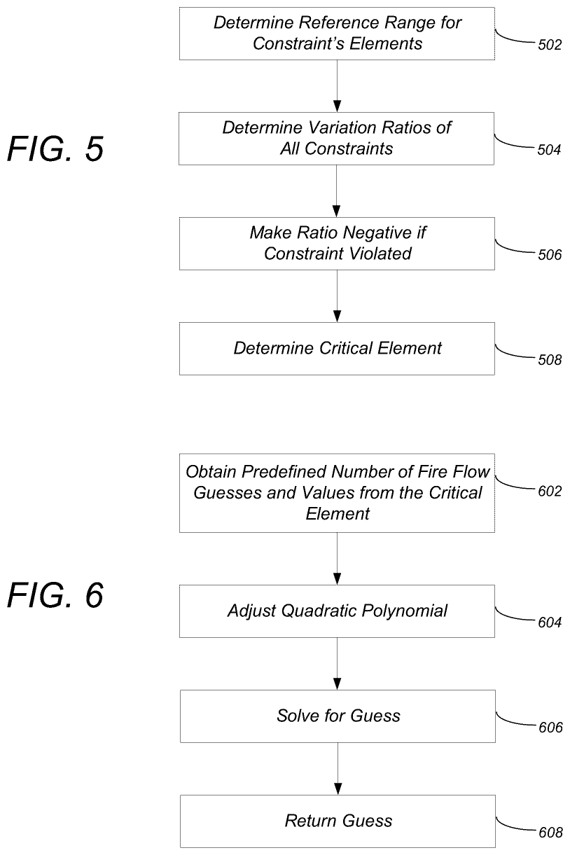

FIG. 5 illustrates the logical flow for finding the critical element (CRIT) in accordance with one or more embodiments of the invention.

At step 502, a reference range is determined for all constraint's elements:
pressure variation range in three base conditions (junctions); or
velocity variation range (pipes).

At step 405, the variation ratios of all constraints are determined as:
current pressure distance from threshold over reference range (junctions); or
current velocity distance from threshold over reference range.

At step 506, if the constraint is violated, the ratio is made negative.

At step 508, the critical element is determined as the element with the smallest ratio.

### PHYS

FIG. 6 illustrates the logical flow for using physically based criteria on the critical element to determine a next guess in accordance with one or more embodiments of the invention.

At step 602, the last/prior n (=3) (i.e., a predefined number) fire flow guesses and last/prior n (i.e., predefined number) values from the critical element are taken/obtained/determined.

At step 604, a quadratic polynomial is adjusted to the three (i.e. predefined number of) data points/values with the new hydrant fire flow guess as a dependent value.

At step 606, the system solves for the guess when the value is equal to the threshold. In other words, the quadratic polynomial is solved to determine the new hydrant fire flow guess. In this regard, when a quadratic value solution is equal to the minimum pressure threshold value, the quadratic value solution is determined as the new fire hydrant flow guess.

At step 606, the new fire hydrant fire flow guess (resulting from the quadratic polynomial solution) is returned.

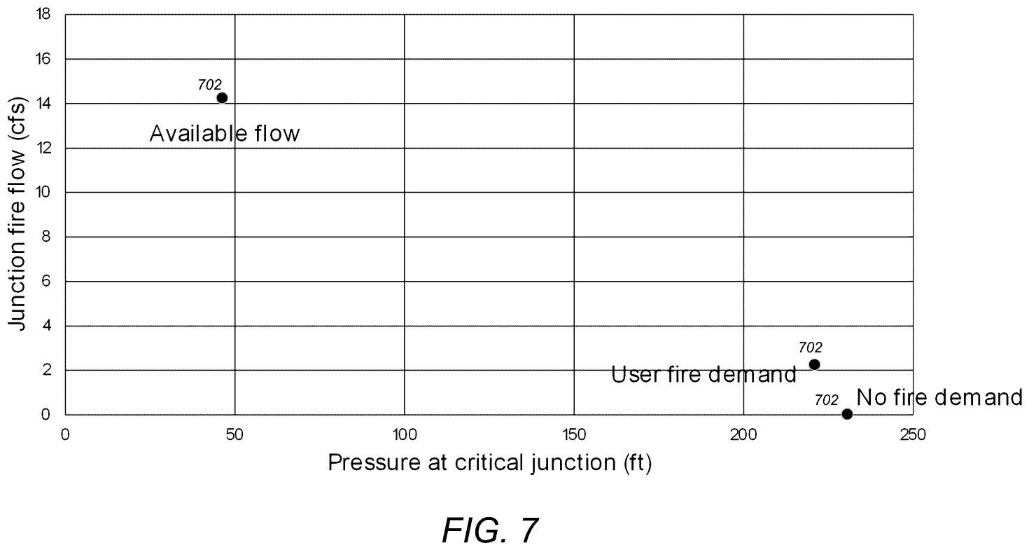

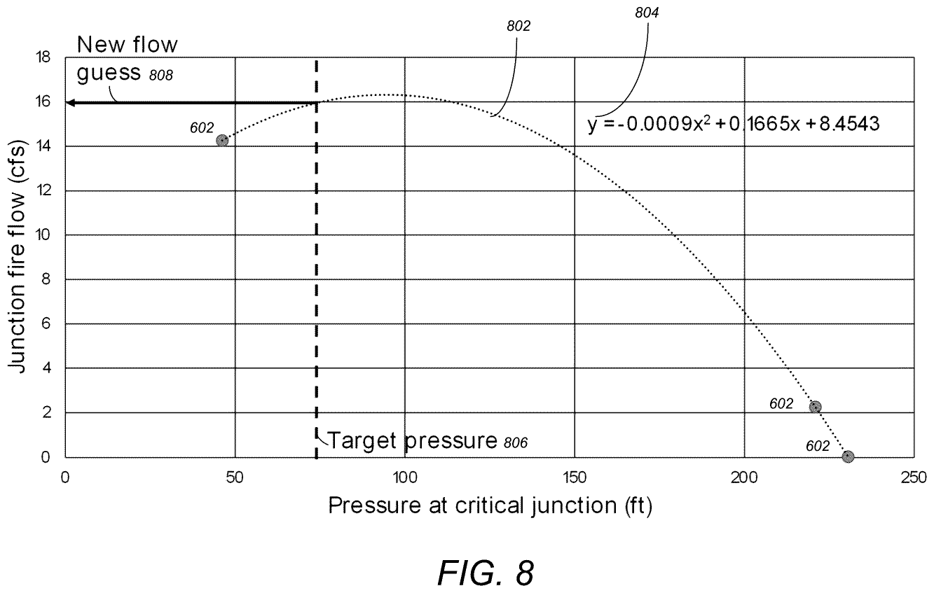

FIG. 7 illustrates the three points that the system is attempting to fit the curve to in accordance with one or more embodiments of the invention. The y-axis is the junction flow and the x-axis is the pressure at the critical junction. The points 702 show the last three guesses (with available flow, user fire demand, and no fire demand). FIG. 8 illustrates the quadratic curve 802 fitting through all three points 702. The quadratic 804 is solved for the target pressure 806 to see the new flow guess 808.

### HEUR

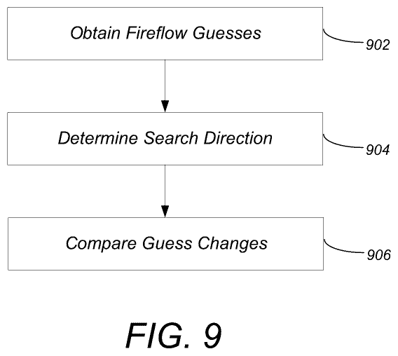

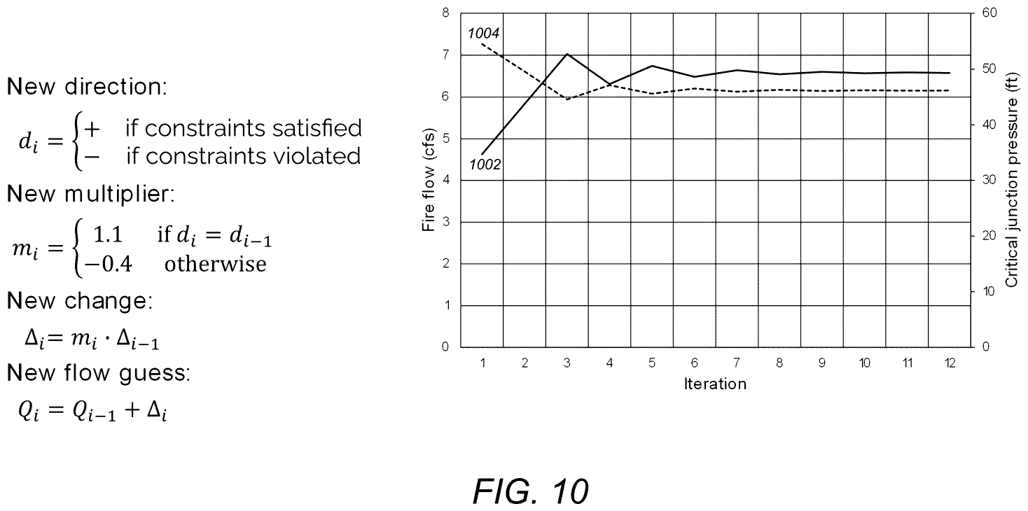

FIG. 9 illustrates the logical flow for the heuristic method for overriding a guess in accordance with one or more embodiments of the invention.

At step 902, the last two (i.e., a predefined number of) fire flow guesses are taken/obtained (this gives the old change). In other words, an old change is determined as the difference between two prior hydrant fire flow guesses.

At step 904, the search direction is determined based on whether the constraints are satisfied. In this regard, a new guess change is determined as the difference between a prior hydrant fire flow guess and the new hydrant fire flow guess.

At step 906, the direction of the new guess change is compared to the old guess. More specifically, a determination is made whether the new guess change is proportional to the old change. The guess change (for the new hydrant fire flow) is increased if in the same direction. The guess change (for the new hydrant fire flow) is decreased if in the opposite direction.

FIG. 10 illustrates the local search heuristic in accordance with one or more embodiments of the invention. Plot 1002 is the fireflow and plot 1004 is the pressure at the junction. The different directions, multiplier, change, and flow guess calculations are illustrated.

### Exemplary Advantages

The following describe one or more unique aspects of embodiments of the invention.

1. Combined (nested) use of a physically-based criteria (PHYS) and a local search heuristic criteria (HEUR) to produce the design fire flow guess for the next iteration. While PHYS is generally faster in normal situations, HEUR is more reliable in avoiding numerical divergence and navigating cases with unusual network operations. Their coupled utilization allows for both speed and reliability. This hybrid approach contrasts with exclusive or phased executions of physically-based and heuristic methods.

2. The heuristic criteria used for guessing the design fire flow uses a local search approach, and does not require knowing beforehand the upper bound of the design fire flow. It also enables estimation when the sampled conditions are not completely reliable, which is necessary to enable single-loop solving (point 4 below). This contrasts with prior art techniques that use a binary search or bisection method that requires such a bound (e.g., prior art modules may be limited by the assumption that the fire flow cannot be larger than the flow for the available condition). The binary search also requires that the sampled conditions are exact to avoid incorrectly discarding feasible solution ranges.

3. All constraints are evaluated simultaneously during every time step to avoid expensive processes to search and verify the selection of critical elements. This contrasts with the one-critical-element-at-a-time approach in prior art solvers that results in multiple nested loops with different candidate critical elements.

4. The entire process for each hydrant is performed in a single loop that simultaneously solves for the design fire flow and the hydraulic conditions present when this flow occurs. This approach does away with the need of solving the hydraulics up to convergence for guesses that are expected to be incorrect. Prior art approaches rely on a four-level nested loop that separately iterates over candidate critical elements, design fire flow guesses, and hydraulic conditions.

5. The use of relative or normalized distances or ratios to determine elements that are critical (CRIT). Prior art systems select potential critical elements based on absolute rather than relative metrics. Moreover, prior art systems do not allow weighting criticality between junctions and pipes during the same phase.

### Hardware Environment

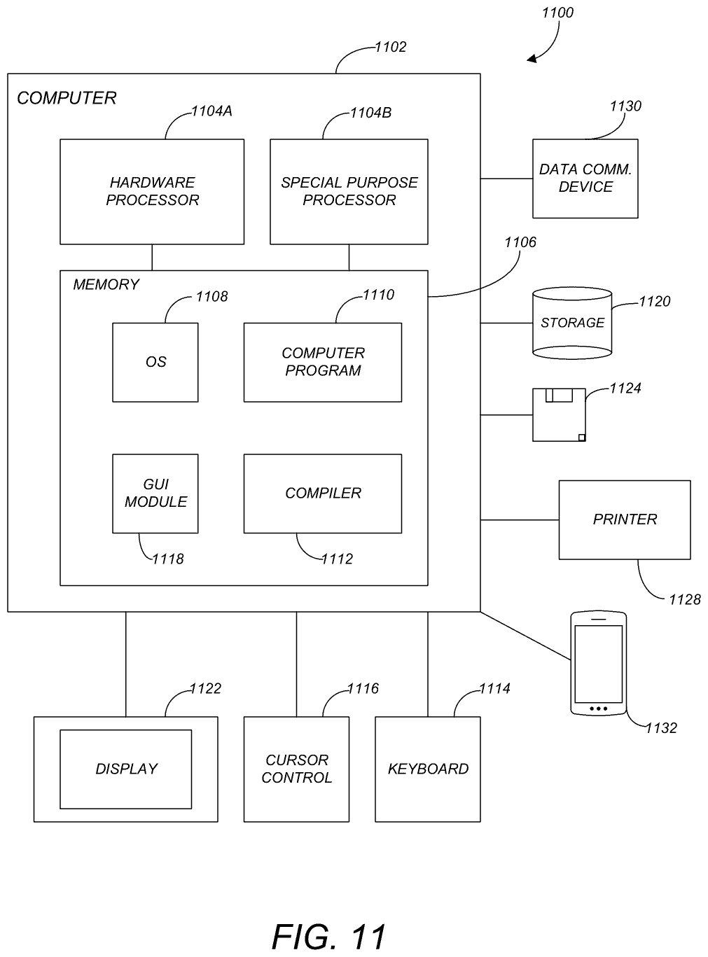

FIG. 11 is an exemplary hardware and software environment 1100 (referred to as a computer-implemented system and/or computer-implemented method) used to implement one or more embodiments of the invention. The hardware and software environment includes a computer 1102 and may include peripherals. Computer 1102 may be a user/client computer, server computer, or may be a database computer. The computer 1102 comprises a hardware processor 1104A and/or a special purpose hardware processor 1104B (hereinafter alternatively collectively referred to as processor 1104) and a memory 1106, such as random access memory (RAM). The computer 1102 may be coupled to, and/or integrated with, other devices, including input/output (I/O) devices such as a keyboard 1114, a cursor control device 1116 (e.g., a mouse, a pointing device, pen and tablet, touch screen, multi-touch device, etc.) and a printer 1128. In one or more embodiments, computer 1102 may be coupled to, or may comprise, a portable or media viewing/listening device 1132 (e.g., an MP3 player, IPOD, NOOK, portable digital video player, cellular device, personal digital assistant, etc.). In yet another embodiment, the computer 1102 may comprise a multi-touch device, mobile phone, gaming system, internet enabled television, television set top box, or other internet enabled device executing on various platforms and operating systems.

In one embodiment, the computer 1102 operates by the hardware processor 1104A performing instructions defined by the computer program 1110 (e.g., a computer-aided design [CAD] application) under control of an operating system 1108. The computer program 1110 and/or the operating system 1108 may be stored in the memory 1106 and may interface with the user and/or other devices to accept input and commands and, based on such input and commands and the instructions defined by the computer program 1110 and operating system 1108, to provide output and results.

Output/results may be presented on the display 1122 or provided to another device for presentation or further processing or action. In one embodiment, the display 1122 comprises a liquid crystal display (LCD) having a plurality of separately addressable liquid crystals. Alternatively, the display 1122 may comprise a light emitting diode (LED) display having clusters of red, green and blue diodes driven together to form full-color pixels. Each liquid crystal or pixel of the display 1122 changes to an opaque or translucent state to form a part of the image on the display in response to the data or information generated by the processor 1104 from the application of the instructions of the computer program 1110 and/or operating system 1108 to the input and commands. The image may be provided through a graphical user interface (GUI) module 1118. Although the GUI module 1118 is depicted as a separate module, the instructions performing the GUI functions can be resident or distributed in the operating system 1108, the computer program 1110, or implemented with special purpose memory and processors.

In one or more embodiments, the display 1122 is integrated with/into the computer 1102 and comprises a multi-touch device having a touch sensing surface (e.g., track pod or touch screen) with the ability to recognize the presence of two or more points of contact with the surface. Examples of multi-touch devices include mobile devices (e.g., IPHONE, NEXUS S, DROID devices, etc.), tablet computers (e.g., IPAD, HP TOUCHPAD, SURFACE Devices, etc.), portable/handheld game/music/video player/console devices (e.g., IPOD TOUCH, MP3 players, NINTENDO SWITCH, PLAYSTATION PORTABLE, etc.), touch tables, and walls (e.g., where an image is projected through acrylic and/or glass, and the image is then backlit with LEDs).

Some or all of the operations performed by the computer 1102 according to the computer program 1110 instructions may be implemented in a special purpose processor 1104B. In this embodiment, some or all of the computer program 1110 instructions may be implemented via firmware instructions stored in a read only memory (ROM), a programmable read only memory (PROM) or flash memory within the special purpose processor 1104B or in memory 1106. The special purpose processor 1104B may also be hardwired through circuit design to perform some or all of the operations to implement the present invention. Further, the special purpose processor 1104B may be a hybrid processor, which includes dedicated circuitry for performing a subset of functions, and other circuits for performing more general functions such as responding to computer program 1110 instructions. In one embodiment, the special purpose processor 1104B is an application specific integrated circuit (ASIC).

The computer 1102 may also implement a compiler 1112 that allows an application or computer program 1110 written in a programming language such as C, C++, Assembly, SQL, PYTHON, PROLOG, MATLAB, RUBY, RAILS, HASKELL, or other language to be translated into processor 1104 readable code. Alternatively, the compiler 1112 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 1110 accesses and manipulates data accepted from I/O devices and stored in the memory 1106 of the computer 1102 using the relationships and logic that were generated using the compiler 1112.

The computer 1102 also optionally comprises an external communication device such as a modem, satellite link, Ethernet card, or other device for accepting input from, and providing output to, other computers 1102.

In one embodiment, instructions implementing the operating system 1108, the computer program 1110, and the compiler 1112 are tangibly embodied in a non-transitory computer-readable medium, e.g., data storage device 1120, which could include one or more fixed or removable data storage devices, such as a zip drive, floppy disc drive 1124, hard drive, CD-ROM drive, tape drive, etc. Further, the operating system 1108 and the computer program 1110 are comprised of computer program 1110 instructions which, when accessed, read and executed by the computer 1102, cause the computer 1102 to perform the steps necessary to implement and/or use the present invention or to load the program of instructions into a memory 1106, thus creating a special purpose data structure causing the computer 1102 to operate as a specially programmed computer executing the method steps described herein. Computer program 1110 and/or operating instructions may also be tangibly embodied in memory 1106 and/or data communications devices 1130, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 1102.

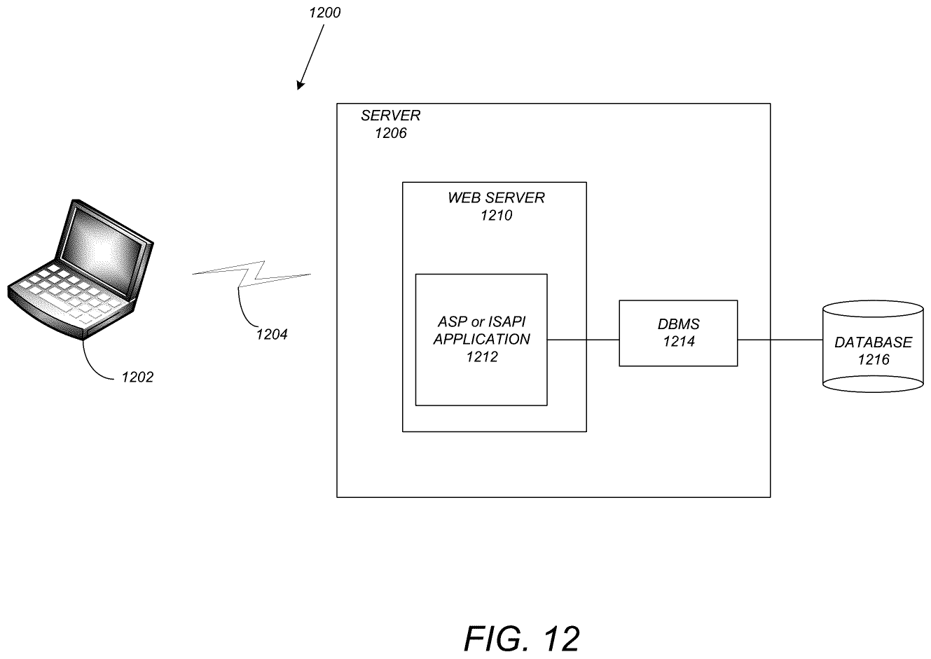

FIG. 12 schematically illustrates a typical distributed/cloud-based computer system 1200 using a network 1204 to connect client computers 1202 to server computers 1206. A typical combination of resources may include a network 1204 comprising the Internet, LANs (local area networks), WANs (wide area networks), SNA (systems network architecture) networks, or the like, clients 1202 that are personal computers or workstations (as set forth in FIG. 11), and servers 1206 that are personal computers, workstations, minicomputers, or mainframes (as set forth in FIG. 11). However, it may be noted that different networks such as a cellular network (e.g., GSM [global system for mobile communications] or otherwise), a satellite based network, or any other type of network may be used to connect clients 1202 and servers 1206 in accordance with embodiments of the invention.

A network 1204 such as the Internet connects clients 1202 to server computers 1206. Network 1204 may utilize ethernet, coaxial cable, wireless communications, radio frequency (RF), etc. to connect and provide the communication between clients 1202 and servers 1206. Further, in a cloud-based computing system, resources (e.g., storage, processors, applications, memory, infrastructure, etc.) in clients 1202 and server computers 1206 may be shared by clients 1202, server computers 1206, and users across one or more networks. Resources may be shared by multiple users and can be dynamically reallocated per demand. In this regard, cloud computing may be referred to as a model for enabling access to a shared pool of configurable computing resources.

Clients 1202 may execute a client application or web browser and communicate with server computers 1206 executing web servers 1210. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 1202 may be downloaded from server computer 1206 to client computers 1202 and installed as a plug-in or ACTIVEX control of a web browser. Accordingly, clients 1202 may utilize ACTIVEX components/component object model (COM) or distributed COM (DCOM) components to provide a user interface on a display of client 1202. The web server 1210 is typically a program such as MICROSOFT'S INTERNET INFORMATION SERVER.

Web server 1210 may host an Active Server Page (ASP) or Internet Server Application Programming Interface (ISAPI) application 1212, which may be executing scripts. The scripts invoke objects that execute business logic (referred to as business objects). The business objects then manipulate data in database 1216 through a database management system (DBMS) 1214. Alternatively, database 1216 may be part of, or connected directly to, client 1202 instead of communicating/obtaining the information from database 1216 across network 1204. When a developer encapsulates the business functionality into objects, the system may be referred to as a component object model (COM) system. Accordingly, the scripts executing on web server 1210 (and/or application 1212) invoke COM objects that implement the business logic. Further, server 1206 may utilize MICROSOFT'S TRANSACTION SERVER (MTS) to access required data stored in database 1216 via an interface such as ADO (Active Data Objects), OLE DB (Object Linking and Embedding DataBase), or ODBC (Open DataBase Connectivity).

Generally, these components 1200-1216 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 1202 and 1206 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 1202 and 1206. Embodiments of the invention are implemented as a software/CAD application on a client 1202 or server computer 1206. Further, as described above, the client 1202 or server computer 1206 may comprise a thin client device or a portable device that has a multi-touch-based display.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, cloud computing, or standalone personal computer, could be used with the present invention. Further, in addition to determining the correct fire flow, embodiments of the invention may provide the ability to run an analysis based on the fire flow to determine whether to add or remove a hydrant.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

### REFERENCES

[Boulos 1997] Boulos, P. F., Rossman, L. A., Orr, C. H., Heath, J. E., Meyer, M. S. (1997). Fire flow computation with network models. Journal/American Water Works Association, 89 (2), 51-56. https://doi.org/10.1002/j.1551-8833.1997.tb08178.x

What is claimed is:

1. A computer-implemented method for determining a hydrant fire flow, comprising:
(a) obtaining inputs comprising:
(i) a water network model;
(ii) a fire hydrant identification for a fire hydrant of interest;
(iii) a list of junctions with a minimum pressure threshold to satisfy and a minimum pressure threshold value, wherein the minimum pressure threshold comprises a first constraint in a set of constraints;
(iv) a list of pipes with a maximum velocity threshold to satisfy and a maximum velocity threshold value, wherein the maximum velocity threshold comprises a second constraint in the set of constraints;
(v) hydraulic results for base conditions for the fire hydrant of interest; and
(vi) parameter values required to determine the hydrant fire flow;
(b) identifying a critical element of the water network model;
(c) determining, based on a physical-based heuristic on the critical element, a new hydrant fire flow guess;
(d) determining whether the new hydrant fire flow guess is in an adequate search direction and:
(i) maintaining the new hydrant fire flow guess when the new hydrant fire flow guess is in an adequate search direction; and
(ii) overriding the new hydrant fire flow guess when the new hydrant fire flow guess is not in an adequate search direction, wherein the overriding utilizes a heuristic method;
(e) assigning the new hydrant fire flow guess as a hydrant demand of the fire hydrant of interest;
(f) updating a network pressure value and a network flow value;
(g) evaluating whether the set of constraints has been satisfied;
(h) reducing the new hydrant fire flow guess if at least one constraint in the set of constraints has been violated;
(i) increasing the new hydrant fire flow guess if all of the constraints in the set of constraints have been satisfied;
(j) evaluating the new hydrant fire flow guess for convergence; and
(k) breaking if there is convergence and returning to step (b) if convergence has not resulted.

2. The computer-implemented method of claim 1, wherein the base conditions comprise:
a static demand comprising a normal water flow demand for normal water operations;
a user-defined fire demand comprising an emergency demand a user estimates will occur during a fire emergency; and
an available fire demand comprising a maximum flow that can be extracted from the fire hydrant without lowering its pressure below a given value.

3. The computer-implemented method of claim 1, wherein the critical element is identified by prioritizing:
violated constraints in the set of constraints; and
a relative pressure distance to the minimum pressure threshold value; and
a relative velocity distance to the maximum velocity threshold value.

4. The computer-implemented method of claim 1, wherein the determining the new hydrant fire flow guess based on a physical-based heuristic comprises:
determining a predefined number of prior hydrant fire flow guesses and prior values from the critical element;
adjusting a quadratic polynomial to the predefined number of values with the new hydrant fire flow guess as a dependent value;
solving the quadratic polynomial to determine the new hydrant fire flow guess, wherein when a quadratic value solution is equal to the minimum pressure threshold value, the quadratic value solution is determined as the new hydrant fire flow guess; and
returning the new hydrant fire flow guess.

5. The computer-implemented method of claim 1, further comprising:
determining the adequate search direction based on whether the first constraint or the second constraint in the set of constraints has been violated, wherein:
the adequate search direction provides for a reduced flow when the first constraint or the second constraint is violated; and
the adequate search direction provides for an increased flow when the first constraint and the second constraint are satisfied.

6. The computer-implemented method of claim 5, wherein the heuristic method comprises:
determining an old change as a difference between two prior hydrant fire flow guesses;
determining a new guess change as a difference between a prior hydrant fire flow guess and the new hydrant fire flow guess;
determining if the new flow guess change is proportional to the old change;
increasing the new hydrant fire flow guess change and overriding the new hydrant fire flow guess based on the increase if in a same direction; and
decreasing the new hydrant fire flow guess change and overriding the new hydrant fire flow guess based on the decrease if in an opposite direction.

7. The computer-implemented method of claim 1, wherein the network pressure value and network flow value are updated using head and flow estimation steps of a hydraulic analysis.

8. The computer-implemented method of claim 1, wherein there is convergence when:
global gradient algorithm (GGA) stopping criteria have been met;
all constraints in the set of constraints have been satisfied; and
the new hydrant fire flow guess is within a threshold distance of a prior hydrant fire flow guess from a last iteration.

9. The computer-implemented method of claim 1, wherein:
the hydrant fire flow is performed for each hydrant in a single loop that simultaneously solves for the hydrant fire flow and hydraulic conditions present when the hydrant fire flow occurs.

10. The computer-implemented method of claim 1, further comprising:
repeating steps (a)-(k) for all fire hydrants in the water network model;
updating a physical manifestation of the water network model based on the new hydrant fire flow guesses.

11. A computer-implemented system for determining a hydrant fire flow, comprising:
(a) a computer having a memory;
(b) a processor executing on the computer;
(c) the memory storing a set of instructions, wherein the set of instructions, when executed by the processor cause the processor to perform operations comprising:
(i) obtaining inputs comprising:
(1) a water network model;
(2) a fire hydrant identification for a fire hydrant of interest;
(3) a list of junctions with a minimum pressure threshold to satisfy and a minimum pressure threshold value, wherein the minimum pressure threshold comprises a first constraint in a set of constraints;
(4) a list of pipes with a maximum velocity threshold to satisfy and a maximum velocity threshold value, wherein the maximum velocity threshold comprises a second constraint in the set of constraints;
(5) hydraulic results for base conditions for the fire hydrant of interest; and
(6) parameter values required to determine the hydrant fire flow;
(ii) identifying a critical element of the water network model;
(iii) determining, based on a physical-based heuristic on the critical element, a new hydrant fire flow guess;
(iv) determining whether the new hydrant fire flow guess is in an adequate search direction and:
(1) maintaining the new hydrant fire flow guess when the new hydrant fire flow guess is in an adequate search direction; and
(2) overriding the new hydrant fire flow guess when the new hydrant fire flow guess is not in an adequate search direction, wherein the overriding utilizes a heuristic method;
(v) assigning the new hydrant fire flow guess as a hydrant demand of the fire hydrant of interest;
(vi) updating a network pressure value and a network flow value;
(vii) evaluating whether the set of constraints has been satisfied;
(viii) reducing the new hydrant fire flow guess if at least one constraint in the set of constraints has been violated;
(ix) increasing the new hydrant fire flow guess if all of the constraints in the set of constraints have been satisfied;
(x) evaluating the new hydrant fire flow guess for convergence; and
(xi) breaking if there is convergence and returning to step (ii) if convergence has not resulted.

12. The computer-implemented system of claim 11, wherein the base conditions comprise:
a static demand comprising a normal water flow demand for normal water operations;
a user-defined fire demand comprising an emergency demand a user estimates will occur during a fire emergency; and
an available fire demand comprising a maximum flow that can be extracted from the fire hydrant without lowering its pressure below a given value.

13. The computer-implemented system of claim 11, wherein the critical element is identified by prioritizing:
violated constraints in the set of constraints; and
a relative pressure distance to the minimum pressure threshold value; and
a relative velocity distance to the maximum velocity threshold value.

14. The computer-implemented system of claim 11, wherein the determining the new hydrant fire flow guess based on a physical-based heuristic comprises:
determining a predefined number of prior hydrant fire flow guesses and prior values from the critical element;
adjusting a quadratic polynomial to the predefined number of values with the new hydrant fire flow guess as a dependent value;
solving the quadratic polynomial to determine the new hydrant fire flow guess, wherein when a quadratic value solution is equal to the minimum pressure threshold value, the quadratic value solution is determined as the new hydrant fire flow guess; and
returning the new hydrant fire flow guess.

15. The computer-implemented system of claim 11, further comprising:
determining the adequate search direction based on whether the first constraint or the second constraint in the set of constraints has been violated, wherein:
the adequate search direction provides for a reduced flow when the first constraint or the second constraint is violated; and
the adequate search direction provides for an increased flow when the first constraint and the second constraint are satisfied.

16. The computer-implemented system of claim 15, wherein the heuristic method comprises:
determining an old change as a difference between two prior hydrant fire flow guesses;
determining a new guess change as a difference between a prior hydrant fire flow guess and the new hydrant fire flow guess;
determining if the new flow guess change is proportional to the old change;
increasing the new hydrant fire flow guess change and overriding the new hydrant fire flow guess based on the increase if in a same direction; and
decreasing the new hydrant fire flow guess change and overriding the new hydrant fire flow guess based on the decrease if in an opposite direction.

17. The computer-implemented system of claim 11, wherein the network pressure value and network flow value are updated using head and flow estimation steps of a hydraulic analysis.

18. The computer-implemented system of claim 11, wherein there is convergence when:
global gradient algorithm (GGA) stopping criteria have been met;
all constraints in the set of constraints have been satisfied; and
the new hydrant fire flow guess is within a threshold distance of a prior hydrant fire flow guess from a last iteration.

19. The computer-implemented system of claim 11, wherein:
the hydrant fire flow is performed for each hydrant in a single loop that simultaneously solves for the hydrant fire flow and hydraulic conditions present when the hydrant fire flow occurs.

20. The computer-implemented system of claim 11, further comprising:
repeating steps (i)-(xi) for all fire hydrants in the water network model;
updating a physical manifestation of the water network model based on the new hydrant fire flow guesses.
